(19) United States
(12) Patent Application Publication
(10) Pub. No.: US 2015/0049096 A1
(43) Pub. Date: Feb. 19, 2015

(54) Systems for Handling Virtual Machine Graphics Processing Requests

(71) Applicant: LEAP Computing, Inc., Austin, TX (US)

(72) Inventor: Frank Joshua Alexander Nataros, Austin, TX (US)

(21) Appl. No.: 14/460,718

(22) Filed: Aug. 15, 2014

Related U.S. Application Data
(60) Provisional application No. 61/866,942, filed on Aug. 16, 2013.

(51) Int. Cl. G06T 1/20; G06F 9/455

(52) U.S. Cl. CPC G06T 1/20; G06F 9/45533
USPC 345/506

(57) ABSTRACT

A system for handling graphics processing requests that includes a hypervisor having access to one or more graphics processing units (GPUs) and a network communication pipeline which transmits unprocessed graphics data and processed graphics data between virtual machines. The system further includes a first virtual machine (VM) having software installed thereon capable of obtaining graphics processing requests and associated unprocessed graphics data generated by the first VM, and transmitting the unprocessed graphics data and receiving processed graphics data via the network communication pipeline, and a second VM having access to the one or more graphics processing units (GPUs) via the hypervisor, and having software installed thereon capable of receiving transmitted unprocessed graphics data and transmitting processed graphics data via the network communication pipeline.

### STATEMENT OF PRIORITY

The present application is a continuation-in-part and claims priority to U.S. Provisional Application No. 61/866,942, titled “System of Using WAN Accelerated Cloud Hosted Environments” and filed Aug. 16, 2013.

### TECHNICAL FIELD

The present disclosure relates to systems for handling graphics processing requests between virtual machines.

### BACKGROUND

Under the traditional desktop computing model, desktop computing users use their desktops to run operating systems such as Microsoft Windows 8, applications such as Adobe Photoshop, and often play games with three dimensional (“3D”) rendering. All of these applications and processes rely on heavy graphics processing which require dedicated hardware, such as multiple central processing units (CPUs), of which the CPUs may each have multiple cores, and dedicated graphics processing units (“GPUs”) with dedicated memory, to execute the application requests in real time.

GPUs are very efficient at manipulating computer graphics, and their highly parallel structure makes them more effective than general-purpose CPUs for algorithms where processing of large blocks of data is done in parallel. Additionally, GPUs can be programmed to perform as general-purpose graphics processing units (“GPGPUs”) to utilize the GPU to perform computations traditionally handled by the CPU in a parallel nature. However, such a configuration leaves the CPUs and GPUs being less than fully utilized all the time, thus an increased efficiency is desirable.

To resolve part of this problem and increase efficiency of the CPUs and GPUs, virtual machines may be implemented. In a typical virtual machine environment, a computer typically has multiple CPUs and GPUs and further includes a virtualization software which creates and manages “virtual machines” (VMs) within the computer's memory. In the virtualized environment, there is typically at least one virtual machine (sometimes called a “privileged” or “host” VM) having direct access to the actual hardware, whereas other virtual machines (sometimes called “guest” VMs) have “virtualized hardware,” wherein they act as though they have direct hardware access, but actually are granted access through the privileged VM.

While virtualization increases the load and use of CPUs and GPUs, other problems are generated, for example, allocation of the CPUs and GPUs. CPU and GPU allocation is a problem for at least the reasons that overhead is required to manage their allocation to the one or more virtualized machines, and bandwidth issues are generated due to increased volume of data being transferred through the bus from each of the VMs requesting processing from the CPU.

Currently, some solutions to this problem include full-time allocation of a GPU to a particular VM, while other solutions include various methods of queuing graphics processing requests and transferring GPU memory pointers to VMs to allow direct access. However, all of these solutions may still process the graphics data through the graphics data bus of the GPUs (e.g., the PCI or PCI-Express bus), thus still having a data bottleneck. Accordingly, there exists a need for providing more efficient processing and queuing of graphics data, doing so with less overhead.

### SUMMARY OF THE INVENTION

The present disclosure introduces various illustrative embodiments for handling graphics processing requests. An embodiment of the present disclosure includes a hypervisor having access to one or more graphics processing units (GPUs) and a network communication pipeline which transmits unprocessed graphics data and processed graphics data between virtual machines. The embodiment further includes a first virtual machine (VM) having software installed thereon capable of obtaining graphics processing requests and associated unprocessed graphics data generated by the first VM, and transmitting the unprocessed graphics data and receiving processed graphics data via the network communication pipeline. Additionally, the embodiment includes a second VM having access to the one or more graphics processing units (GPUs) via the hypervisor, and having software installed thereon capable of receiving transmitted unprocessed graphics data and transmitting processed graphics data via the network communication pipeline.

Although the disclosure has been described and illustrated with respect to exemplary objects thereof, it will be understood by those skilled in the art that various other changes, omissions, and additions may be made therein and thereto without departing from the scope of the present disclosure.

### BRIEF DESCRIPTION OF THE DRAWINGS

The following figures are included to illustrate certain aspects of the present invention, and should not be viewed as an exclusive embodiments. The subject matter disclosed is capable of considerable modification, alteration, and equivalents in form and function, as will occur to one having ordinary skill in the art and the benefit of this disclosure.

FIG. 1 is a block diagram of a system that may be employed for providing a virtualized environment, according to one or more embodiments.

FIG. 2 is a block diagram of a system for handling graphics processing requests that employs a network communication pipeline, according to one or more embodiments

FIG. 3 illustrates a network packet for transmitting graphics data over the network communication pipeline, according to one or more embodiments.

FIG. 4 is a flow diagram of an illustrative method for handling graphics processing requests, according to one or more embodiments.

FIG. 5 is a block diagram of computing device for implementing graphics processing requests, according to one or more embodiments.

### DETAILED DESCRIPTION

The present disclosure relates to systems and methods for handling graphics processing requests. An illustrative embodiment of the present disclosure includes a hypervisor having access to one or more graphics processing units (GPUs) and a network communication pipeline which transmits unprocessed graphics data and processed graphics data between virtual machines. The embodiment further includes a first virtual machine (VM) having software installed thereon capable of obtaining graphics processing requests and associated unprocessed graphics data generated by the first VM, and transmitting the unprocessed graphics data and receiving processed graphics data via the network communication pipeline. Additionally, the embodiment includes a second VM having access to the one or more graphics processing units (GPUs) via the hypervisor, and having software installed thereon capable of receiving transmitted unprocessed graphics data and transmitting processed graphics data via the network communication pipeline.

As used herein, a GPGPU may be interchangeably used with a GPU. However, one of skill in the art may recognize the flexibility of the current invention and any reference to a GPU/GPGPU can be substituted for any particular hardware or ASIC that is used for specific individual applications of the inventive method. (i.e., a sound card, or specific hardware to solve for SHA256 encryption). As such, GPUs are referenced in the specification as merely an exemplary embodiment of the disclosed method, but is not intended to be a limitation of the method's capability.

Referring now to the drawings, wherein like reference numbers are used herein to designate like elements throughout the various views and embodiments of a unit. The figures are not necessarily drawn to scale, and in some instances the drawings have been exaggerated and/or simplified in places for illustrative purposes only. One of the ordinary skill in the art will appreciate the many possible applications and variations based on the following examples of possible embodiments. As used herein, the “present disclosure” refers to any one of the embodiments described throughout this document and does not mean that all claimed embodiments must include the referenced aspects.

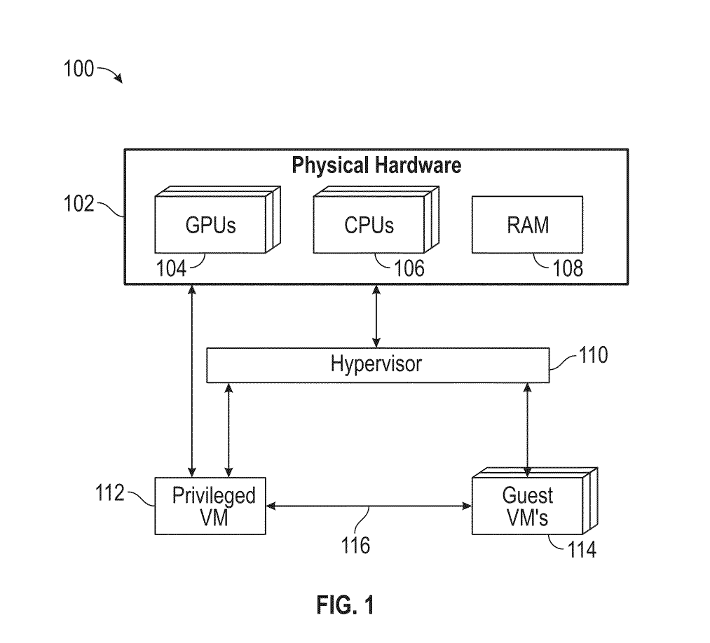

FIG. 1 depicts a block diagram of a system 100 that may be employed for providing a virtualized environment, according to one or more embodiments. As depicted, the system 100 includes physical hardware 102, including one or more GPUs 104, one or more processors or central processing units (CPUs) 106, and volatile and/or non-volatile random access memory (RAM) 108. In some embodiments, the RAM 108 may be employed as a non-transitory computer-readable medium for storing instructions that may cause the CPUs 106 and/or the GPUs 104 to perform graphics processing. The system 100 further includes a hypervisor 110 implementation of a virtualization program. However, one of skill in the art will appreciate that any virtualization program or virtual machine monitoring program may be employed without departing from the scope of the present disclosure.

The virtualization program (e.g., the hypervisor 110) can create and control virtual machines (VMs), and further virtualizes the physical hardware 102, including the GPUs 104, CPUs 106, and RAM 108 such that it appears to natively exist on the virtual machines. Thus, the Hypervisor 110 may be capable of, but is not required to, acting as an input/output memory management unit (“IOMMU”). Currently, there exist at least two forms of IOMMUs on the market, including the Intel Virtualization Technology for Directed I/O (VT-d) and the AMD-V with IOMMU support. However, other forms of IOMMU may be used as recognized by one of skill in the art.

As depicted, the system 100 includes a privileged VM 112 and one or more guest VMs 114, however a plurality of privileged VMs 112 may be present in other embodiments. Typically, the privileged VM 110 (also known as a “host” VM), has direct access to the physical hardware 102, whereas the guest VMs 114 do not and therefore communicate their graphics request and data to the privileged VM 112 via a graphics pipeline 116 such as the PCI-Express bus due to the guest VMs 114 acting as though there is native access to the physical hardware 102 devices and thus attempting to use according default pipelines. The privileged VM 112 may then employ, for example, the one or more GPUs 104 to process the raw or unprocessed graphics data from the guest VM 114, and then return processed graphics data back to the guest VM 114.

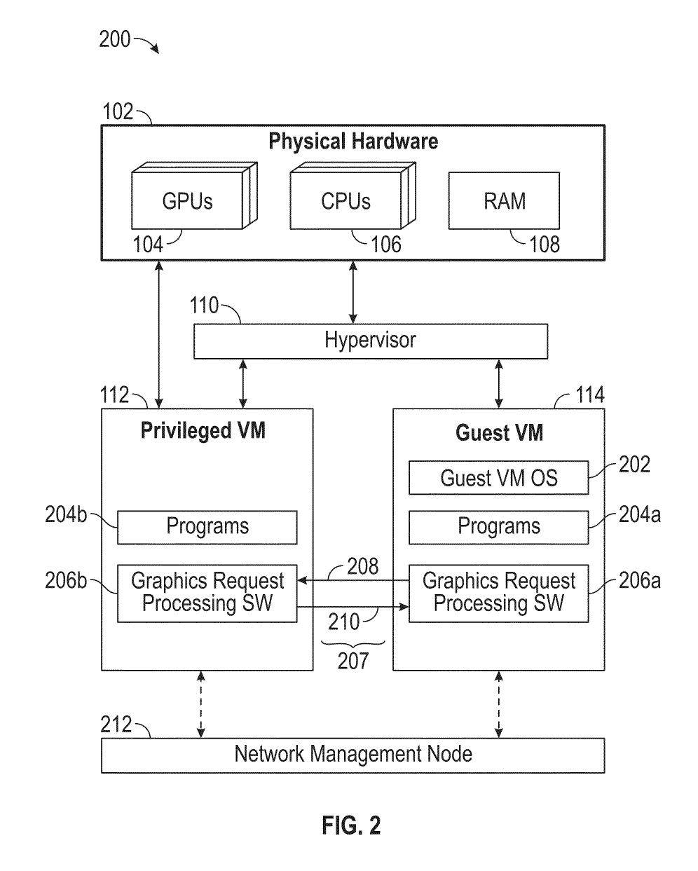

FIG. 2 illustrates a system 200 for handling graphics processing requests that employs a network communication pipeline, according to one or more embodiments. Similar to the system 100 (FIG. 1), the system 200 includes the set of physical hardware 102, including the one or more GPUs 104, one or more CPUs 106, RAM 108, and the hypervisor 110 as a virtualization program enabling creation and management of virtual machines and virtualization of the physical hardware 102 thereto.

As depicted, the system 200 further includes the privileged VM 112 and guest VM 114. The guest VM 114 includes a guest VM operating system (OS) 202, programs 204a and/or third-party graphics processing applications installed thereon that may require graphics processing (e.g., videogames, Adobe Photoshop, and the like), and a graphics request processing software 206a (hereinafter “Software 206a”). The privileged VM 112 also includes at least some of the same programs 204b and third-party graphics processing applications, and further includes graphics request processing software (hereinafter “Software 206b”) corresponding and/or able to act as a counterpart to the Software 206a. However, unlike the more standard virtualization configuration, such as depicted in system 100 (FIG. 1), the Software 206a and Software 206b form a network graphics pipeline 207.

Advantageously, and as can be appreciated by one skilled in the art, all components of the system 200, including the physical hardware 102, hypervisor 110, privileged VM 112, and guest VM 114 may be arranged within a single “bare-metal” box, or alternatively may be arranged or run in separate bare-metal boxes, and communicate using standard communications means, such as Ethernet, fiber, or wireless. Therefore, world-wide access is allowed, including implementation via cloud computing.

The network communications pipeline 207 is a network “pipeline” which transfers graphics data, thus enabling transferring unprocessed graphics data 208 from the guest VM 114 to the privileged VM 112 and transfer of processed graphics data 210 from the privileged VM 112 back to the guest VM 114. In some embodiments, the network communications pipeline may be one of a TCP, IP, TCP/IP, or UDP protocol as known to those skilled in the art. The network communications pipeline 207 is capable of streaming data between the guest VM 114 and privileged VM 112, for example, via implementation of buffers in the graphics request processing SW 206a and 206b and by means known to those skilled in the art.

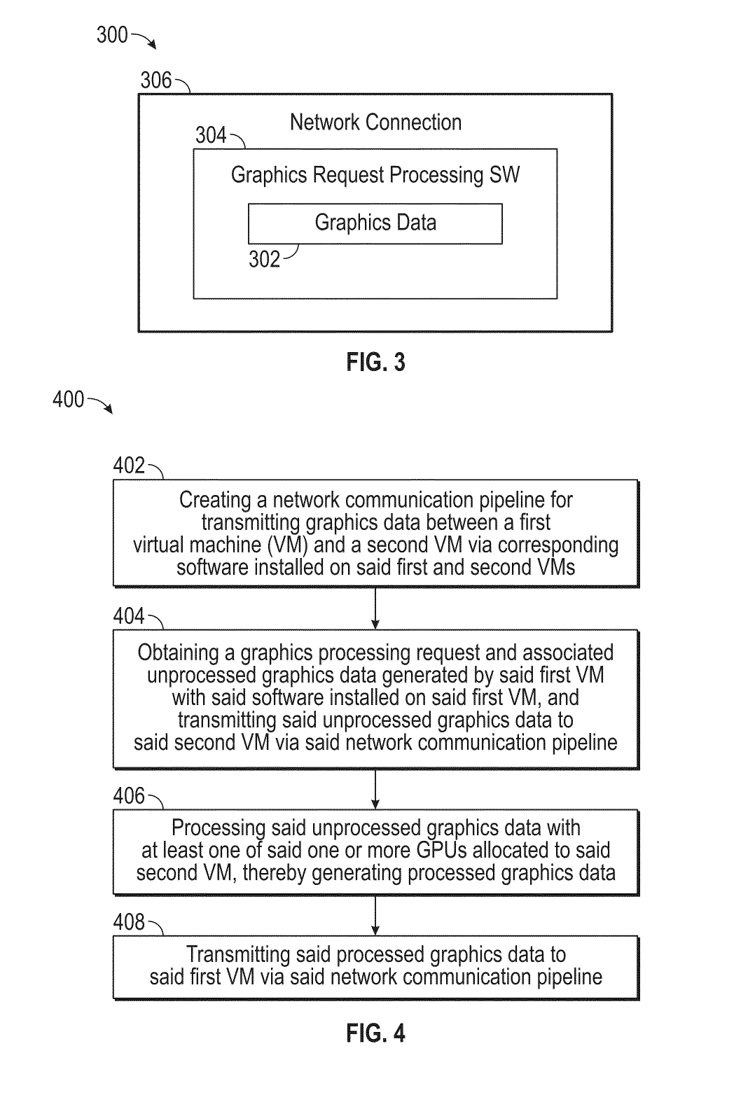

Briefly referring to FIG. 3, illustrated is a network packet 300 for transmitting graphics data over the network communication pipeline 207, according to one or more embodiments. As depicted, a network packet 300 includes graphics data 302 encapsulated within a graphics request processing SW layer 304, which is further encapsulated within a network connection layer 306.

The graphics data 302 may be either the unprocessed graphics data 208 (FIG. 2) or the processed graphics data 210 (FIG. 2), as the overall network packet 300 likely has the same general encapsulation scheme for ease and uniformity during both transmissions. The graphics request processing SW layer 304 represents a layer that is added by the transmitting VM (e.g., the guest VM 114 transmitting unprocessed graphics data 208) that, in some embodiments and for example, may inform the receiving VM (e.g., the privileged VM 112) of what program 204a generated the graphics request and data so that the receiving VM (e.g., the privileged VM 112) may open the same program 204b to process the unprocessed graphics data 208. The network connection layer 306 is generally any information required for transmission over the particular type of network connection as known to those skilled in the art (e.g., TCP, IP, UDP, etc.).

In one exemplary operation, the graphics request processing software 206a of the guest VM 114 obtains a graphics request (e.g., from one of the programs 204a). Upon intercepting a graphics request, the graphics request processing software 206a encapsulates the unprocessed graphics data 302 with the graphics request processing software layer information 304, and then further encapsulates the packet with the network connection layer 306. Upon receipt by the privileged VM 112, the network packet 300 is de-encapsulated in reverse order, removing the networking connection layer 306, and then the graphics request processing software layer 304, thereby enabling the privileged VM 112 to interact with the GPUs 104 to process the unprocessed graphics data 302.

Upon completion of processing, the processed graphics data 210 is generated and encapsulated with the graphics request processing SW layer 304 and network connection layer 306 similar to the above described, and transmitted back to the guest VM 114, where the network packet 300 is then de-encapsulated in reverse order again to deliver the processed graphics data to the program 204a.

As used herein and throughout the present disclosure, the term “encapsulated” should not be limited to actual enclosure of one set of data within another set of data, but refers to the graphics data, either unprocessed 208 or processed 210, and being transmitted or received by the guest VM 114 or the privileged VM 112, being combined in any fashion with additional information as may be required to interact with the graphics request processing SW 206a or 206b and/or to be transmitted or received over the network communication pipeline 207.

Referring again back to FIG. 2, in some embodiments, the guest VM 114 graphics request processing SW 206a encodes or compresses the unprocessed graphics data prior to transmitting such data to the privileged VM 112 for processing. Advantageously, doing such may provide more secure communications and/or require less bandwidth and/or enable faster processing by the privileged VM 112 due to having to process less overall data.

The system 200 may further include a network management node 212. The network management node 212 may be a physical or virtual machine which acts as a gateway for all machines (real and virtual) to access the network. Thus, in order for the privileged VM 112 to have access to the network and interact with the guest VM 114, both must be authenticated and granted access by the network management node 212. However, in some embodiments, this is only required during an initialization or first-logon for each machine, and thus is not require for every interaction.

Alternatively, the guest VM 114 and privileged VM 112 may include other means of authentication to prevent access or use of the machines. For example, both VM's 114 and 112 may include authentication means at the time of login to the VM. In other embodiments, the graphics request processing SW 206a,b may include proprietary authentication means, either by additional passwords required on each end (i.e., on both the guest VM 114 and the privileged VM 112), or possibly via a security token or security key-like system as known to those skilled in the art.

FIG. 4 is a flow diagram of an illustrative method 400 for handling graphics processing requests, according to one or more embodiments. At block 402, the method 400 creates a network communication pipeline for transmitting graphics data between a first VM and a second VM via corresponding software installed on each of the first and second VMs (i.e., graphics request processing SW), wherein the second VM has access to one or more graphics processing units (GPUs) via a hypervisor. In some embodiments, the second VM may also be called a “privileged” or “host” VM due to having direct access to the one or more GPUs.

In other embodiments, the first VM includes software beyond the graphics request processing SW, such as a first VM OS and programs, including third-party programs, which require graphics processing (e.g., videogames, Adobe Photoshop, and the like). The second VM may also include programs and third-party programs which require graphics processing (e.g., videogames, Adobe Photoshop, and the like) to handle processing the unprocessed graphics data from the first VM.

In some embodiments, the network communications pipeline may be one of a TCP, IP, TCP/IP, or UDP protocol as known to those skilled in the art. In further embodiments, the network communications pipeline is capable of streaming data between the first VM and second VM, for example, via implementation of buffers in the graphics request processing SW on each of the first and second VMs by means known to those skilled in the art.

At block 404, the software of the first VM obtains or intercepts a graphics processing request and associated unprocessed graphics data from the first VM and transmits the unprocessed graphics data to the second VM via the network communication pipeline. In some embodiments, the unprocessed graphics data may be encapsulated into a form suitable for transmission over the network communication pipeline prior to transmission to the second VM. For example, the unprocessed graphics data may be encapsulated first with additional information associated with the graphics request processing software, and then may be further encapsulated with information associated and/or required for proper transmission over the network communication pipeline.

In some embodiments, the graphics request processing SW on the first VM may remove a portion of the unprocessed graphics data prior to encapsulating and transmitting the unprocessed graphics data to the second VM. In other embodiments, the graphics request processing SW may encode or compress the unprocessed graphics data prior to transmitting such to the second VM for processing. Advantageously, doing such may provide more secure communications and/or require less bandwidth and/or enable faster processing by the second VM due to having less overall data to process.

Upon arrival at the second VM, the encapsulated graphics data is un-encapsulated in reverse order from the encapsulation discussed above. At block 406, the unprocessed graphics data is processed with at least one or more of the GPUs allocated to the second VM, thereby generating processed graphics data. In some embodiments, at least one of the one or more GPUs may be pre-assigned to the second VM. The remaining GPUs are available to be assigned to other privileged GPUs. In other embodiments, the memory of the one or more GPUs is only assigned to the second VM for a single graphics processing request. Advantageously, doing such allocation only for a single graphics processing requests increases security and prevents accidental sharing of memory between processes or requests.

In some embodiments, the method may employ a queue to process unprocessed graphics data received from both the first VM and a third VM. The queue may process the requests as they originate (first request is processed first, second request is processed second, etc.), or may intelligently queue the requests based on predefined criteria.

The second VM thereby generates processed graphics data, which is encapsulated similar to discussed above and transmitted back to the first VM via the network communication pipeline, as at block 408. The processed graphics data is then received and de-encapsulated by the first VM, where the processed graphics data is delivered to the program on the first VM which originally submitted the graphics request.

In further embodiments, the first VM and second VM may include means of authentication to prevent access or use of the machines. For example, both VM's may include authentication means at the time of login to the VM. In other embodiments, the graphics request processing SW may include proprietary authentication means, either by additional passwords required on each end (i.e., on both the first VM and second VM), or possibly via a security token or security key-like system as known to those skilled in the art.

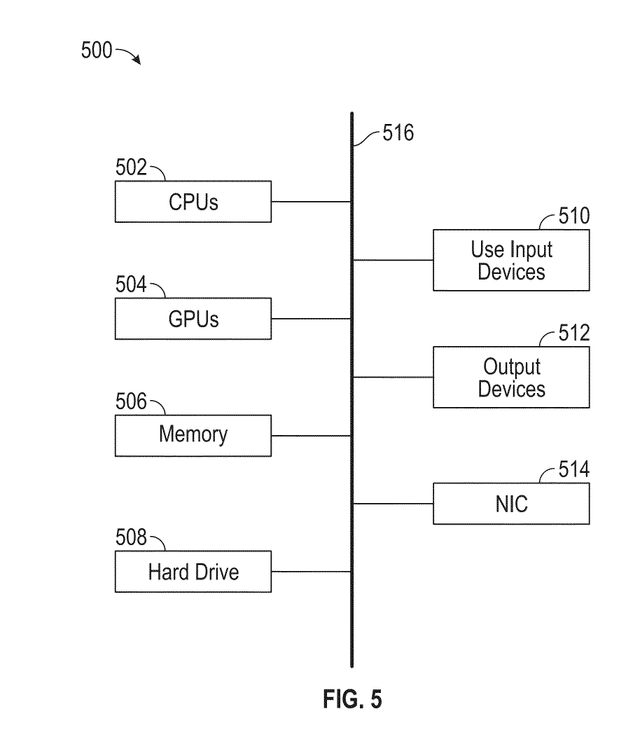

FIG. 5 is a block diagram of computing device 500 for implementing graphics processing requests, such as those described in the above systems and methods, according to one or more embodiments. As depicted, the computing device 500 includes one or more processors or CPUs 502, one or more GPUs 504, memory 506, and a hard drive 508. The computing device 500 further includes user input devices 510, output devices 512, and a network interface card (NIC) 514, all of which is electrically coupled together by a bus 516.

The CPUs 502 may include, for example and without limitation, one or more processors, (each processor having one or more cores), microprocessors, field programmable gate arrays (FPGAs), application specific integrated circuits (ASICs) or other types of processing units that may interpret and execute instructions as known to those skilled in the art. The memory 506 includes non-transitory computer-readable storage medium of any sort (volatile or non-volatile) as known to those skilled in the art. User input devices 510 may include, for example and without limitation, a keyboard, mouse, touchscreen, or other input device that may operate a program which make graphics calls. Exemplary output devices may include monitors, printers, or the like.

The NIC 514 enables the computing device 500 to interact with other computing devices. Advantageously, this allows for virtual machines on separate “bare-metal” boxes or computers to interact via any network, including a local area network (LAN) or wide area network (WAN), such as the internet. Thus, such access may provide the computing device 500 access to additional GPUs for graphics processing. Moreover, as each machine may be assigned a unique IP address, the VMs may restrict access from and to other VMs to increase security and prevent intrusion.

As stated above, in some embodiments, the systems and methods described and discussed herein may be implemented by the computing device 500. In one such embodiment, a non-transitory computer-readable storage medium (e.g., the memory 506 or hard drive 508) has instructions stored thereon which, when executed by the one or more CPUs 502, may cause the CPUs 502 to perform operations for handling the above described graphics processing requests, including creating a network communication pipeline for transmitting graphics data between a first virtual machine (VM) and a second VM via corresponding software installed on said first and second VMs, wherein said second VM has access to one or more GPUs (e.g., the GPUs 504) via a hypervisor. The operations may further include obtaining a graphics processing request and associated unprocessed graphics data generated by the first VM with the software installed on the first VM, and transmitting the unprocessed graphics data to the second VM via the network communication pipeline. Additionally, the operations may further include processing the unprocessed graphics data with at least one of the one or more GPUs (e.g., the GPUs 504) allocated to the second VM, thereby generating processed graphics data, and transmitting said processed graphics data to said first VM via said network communication pipeline.

What is claimed is:

1. A system for handling graphics processing requests, comprising:
a hypervisor having access to one or more graphics processing units (GPUs);
a network communication pipeline which transmits unprocessed graphics data and processed graphics data between virtual machines;
a first virtual machine (VM) having software installed thereon capable of obtaining graphics processing requests and associated unprocessed graphics data generated by said first VM, and transmitting said unprocessed graphics data and receiving processed graphics data via said network communication pipeline; and
a second VM having access to said one or more graphics processing units (GPUs) via said hypervisor, and having software installed thereon capable of receiving transmitted unprocessed graphics data and transmitting processed graphics data via said network communication pipeline.

2. The system of claim 1, wherein said network communication pipeline is one of a TCP, IP, TCP/IP, or UDP protocol.

3. The system of claim 1, further comprising performing at least one of encoding or compression of said unprocessed graphics data with said first VM prior to transmitting said unprocessed graphics data via said network communication pipeline.

4. The system of claim 1, further comprising a buffer for buffering and streaming between said first and second VMs.

5. The system of claim 1, further comprising a third-party graphics processing application installed on said second VM to process said unprocessed graphics data.

6. The system of claim 1, wherein memory of said one or more GPUs is only assigned to said second VM for a single graphics processing request.

7. The system of claim 1, further comprising an authentication means for performing authentication between said first and second VMs.

8. The system of claim 1, further comprising a management node.

9. The system of claim 1, further comprising a queue and a third VM, wherein said second VM queues unprocessed data from said first and third VM based upon resource availability of said one or more GPUs.
